(19) United States
(12) Patent Application Publication
(10) Pub. No.: US 2007/0211961 A1
(43) Pub. Date: Sep. 13, 2007

(54) Image processing apparatus, method, and program

(75) Inventor: Mika Sugimoto, Asaka-shi (JP)

Correspondence Address: BIRCH STEWART KOLASCH & BIRCH, PO BOX 747, FALLS CHURCH, VA, 22040-0747, US

(73) Assignee: FUJIFILM Corporation

(21) Appl. No.: 11/711,743

(22) Filed: Feb. 28, 2007

(30) Foreign Application Priority Data
Mar. 7, 2006 (JP) 2006-060979

(51) Int. Cl. G06K 9/36; G06K 9/00

(52) U.S. Cl. 382/276; 382/181

(57) ABSTRACT

An image processing apparatus which generates moving image data on the basis of a still image, comprising:

a database storing a moving image template specifying a display condition dependent on whether or not a particular region has been extracted;

a region extracting section which extracts the particular region from the still image; and

a moving image data generating section which reads from the database a moving image template specifying a display condition dependent on whether or not the particular region has been extracted by the region extracting section and generates moving image data based on the still image and the moving image template.

### BACKGROUND OF THE INVENTION

1. Field of the Invention

The present invention relates to a technique for generating a moving image on the basis of still images.

2. Description of the Related Art

Slideshow function, which was once an application function for personal computers, is today included in digital cameras and camera-equipped cellular phones. Fast-moving slideshows such as photoclips are emerging that can provide more than the effect of simply transitioning from one still image to another.

Such slideshows zoom in and out on a portion of a still image or superimpose a template image on a portion of still image. However, depending on images, a possible main subject such as a person or animal can be cut in half or can be overlapped by a template image.

To solve the problem, a technique disclosed in Japanese Patent Application Laid-Open No. 2005-182196 extracts a region where a human face may exist from an image and uses the face region to generate a moving slideshow with techniques such as zooming, panning, and masking.

The technique described in Japanese Patent Application Laid-Open No. 2005-182196 is not effective when the main subject of interest is an object other than a human face, for example an animal or car. Furthermore, a human face cannot necessarily accurately extracted and therefore it may be improper to automatically setting a face region on the basis of an inaccurate face extraction.

### SUMMARY OF THE INVENTION

The present invention has been made in view of these problems and an object of the present invention is to generate a moving image to which an appropriate display effect is added according to a region extracted.

The present invention provides an image processing apparatus which generates moving image data on the basis of a still image, including: a database storing a moving image template specifying a display condition dependent on whether or not a particular region has been extracted; a region extracting section which extracts the particular region from the still image; and a moving image data generating section which reads from the database a moving image template specifying a display condition dependent on whether or not the particular region has been extracted by the region extracting section and generates moving image data based on the still image and the moving image template.

According to this aspect of the present invention, a display condition is changed in accordance with whether or not a particular region has been extracted. As a result, the visibility of the particular region in a moving image is improved and the visual interest is added to the moving image.

Preferably, the database stores a moving image template which specifies a display condition dependent on whether or not the particular region has been extracted and on the accuracy of extraction of the particular region, and the moving image data generating section reads from the database a moving image template which specifies a display condition dependent on whether or not a particular region has been extracted by the region extracting section and on the accuracy of extraction and generates moving image data based on the still image and the moving image template.

Thus, the display condition is changed in accordance with the accuracy of extraction. As a result, the visibility of the particular region in a moving image and the visual interest of the moving image are further improved.

Preferably, the database stores a moving image template specifying a display condition dependent on whether or not the particular region has been extracted and on the type of the extracted particular region; the region extracting section extracts the particular region and the type of the particular region from the still image; and the moving image data generating section reads from the database a moving image template specifying a display condition dependent on whether or not a particular region has been extracted by the region extracting section and on the type of the extracted particular region and generates moving image data based on the still image and the moving image template.

Thus, the display condition is changed in accordance with the type of extracted region. As a result, an appropriate visual effect is added to the particular region in a moving image and the visual interest of the moving image is increased.

The particular region includes a region where a human face exists.

The present invention provides an image processing method for generating a moving image data on the basis of a still image, including the steps of: storing a moving image template in a database, the moving image template specifying a display condition dependent on whether or not a particular region has been extracted; extracting the particular region from the still image; and reading from the database a moving image template specifying a display condition dependent on whether or not the particular region has been extracted and generating moving image data based on the still image and the moving image template.

The present invention also includes a program for causing a computer to perform the image processing method.

According to the present invention, the display condition of a moving image is changed in accordance with whether or not a particular region has been extracted, the accuracy of the extraction, or the type of the extracted particular region. As a result, the visibility of the particular region in a moving image is improved, a proper visual effect is added to the particular region, and the visual interest of the moving image is increased.

### BRIEF DESCRIPTION OF THE DRAWINGS

FIG. 1 schematically shows a configuration of a slideshow generating apparatus according to a first embodiment;

FIG. 2 is a conceptual diagram showing information stored in a template managing section according to the first embodiment;

FIG. 3 is a flowchart of an example of a flow of process performed by the slideshow generating apparatus according to the first embodiment;

FIG. 4 is a conceptual diagram illustrating a moving image generated in a case where a particular region has been extracted;

FIG. 5 is a conceptual diagram illustrating a moving image generated in a case where a particular region has not been extracted;

FIG. 6 is a conceptual diagram showing information stored in a template managing section according to a second embodiment;

FIG. 7 is a flowchart of an example of a flow of process performed by a slideshow generating apparatus according to the second embodiment;

FIG. 8 is a conceptual diagram of moving images according to the accuracy of extraction of a particular region (human face);

FIG. 9 is a conceptual diagram of moving images according to the accuracy of extraction of a particular region (animal);

FIG. 10 is a conceptual diagram of information stored in a template managing section according to a third embodiment;

FIG. 11 is a flowchart of an example of a process performed by a slideshow generating apparatus according to the third embodiment;

FIG. 12 is a conceptual diagram illustrating a moving image according to the type of a particular region (human face); and

FIG. 13 is a conceptual diagram illustrating a moving image according to the type of a particular region (animal).

### DETAILED DESCRIPTION OF THE PREFERRED EMBODIMENTS

### First Embodiment

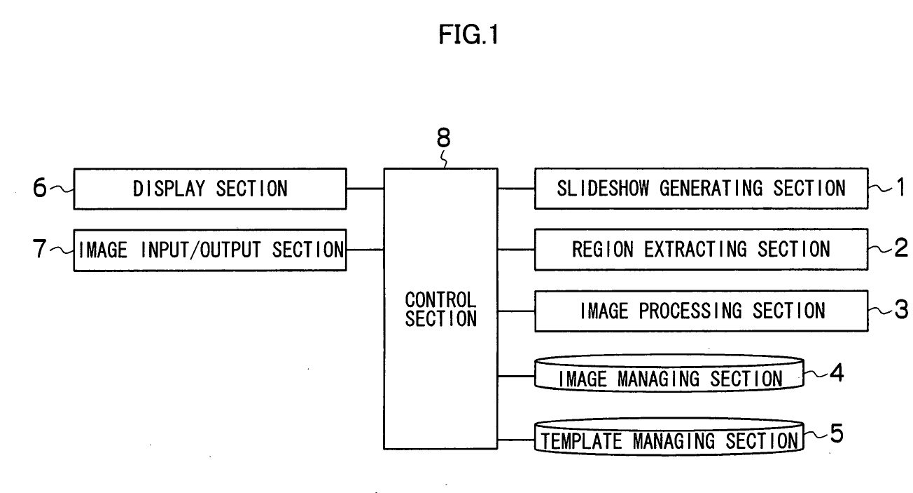

FIG. 1 is a block diagram showing a configuration of a slideshow generating apparatus according to a preferred embodiment of the present invention. The slideshow generating apparatus includes a control section 8, a slideshow generating section 1, a region extracting section 2, an image processing section 3, an image managing section 4, a template managing section 5, a display section 6, and an image input/output section 7.

The image managing section 4 is a storage medium, such as a hard disk, that stores still images input through the image input/output section 7 connected to a digital still camera or the like.

The slideshow generating section 1 generates moving image data or moving image data with audio data (a slideshow) in a format that can be played back on a device such as a cellular phone or a digital camera on the basis of one or more desired still images selected by a user from among the images stored in the image managing section 4 (for example a file in JPEG format, hereinafter referred to as an original image or images) and the type of operation or a display condition specified in a desired template selected from among the templates stored in the template managing section 5.

Examples of various types of operations may include: the type of “effect” such as the effect of randomly selecting one of multiple still image to display, moving one or more still images on a screen horizontally or vertically (panning or tilting) with a given rate, displaying a series of still images like a slideshow, zooming in or out an image, hiding (masking) a region of an image other than a particular region, and rotating an image as well as the type of “superimposed frame”, which are a still or moving image such as the image of flowers or window frame superimposed on a moving image. The operation types may include the title of “background music” played in synchronization with playback of moving image data.

Generated moving image data may be in a format such as an MP 3 file that is independent of a template or may be in a format such as an animation GIF in which a moving image is played by using still images combined with a template.

A template, which will not be detailed herein, can also define a document associated with playback of original images, the coordinates of objects such as characters and icons and display conditions such as sizes and colors.

The region extracting section 2 extracts a particular region of each original image, for example a region where a human face, an animal such as a cat or dog, or other object such as a car is found. The region extracting section 2 outputs a signal to the slideshow generating section 1 indicating whether or not a particular region has been extracted. The signal indicating a particular region has been extracted is referred to as “Extraction OK” and the signal indicating a particular region has not been extracted is referred to as “Extraction NG”.

The template managing section 5 is a database storing templates and template management information.

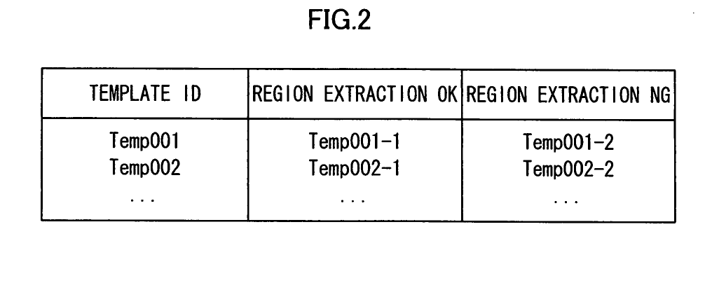

FIG. 2 shows an example of template management information stored in the template managing section 5. As shown in FIG. 2 the template management information associates an indication of whether or not a particular region has been extracted by the region extracting section 2 and identification number (ID) of a template of a display condition that matches that indication with the ID of a template of each operation type.

In this example, the template type “Temp001” and the “Extraction OK” signal are associated with the display condition “temp001-1” and the template type “Temp001” and the “Extraction NG” signal are associated with the display condition “temp001-2”.

One example of display condition used when a particular region has been extracted is to superimpose on the original image a masking image having a hollow portion that coincides with the position where the particular region exists. If a particular region has not been extracted, a masking image having a hollow portion of a certain size may be superimposed on a predetermined position of the original image such as near the center of the original image. Another example of display condition used when a particular region has been extracted may be to combine the original image with a superimposed frame or moving image that skirts around the position where the particular region exists.

The image processing section 3 generates a video signal (for example an NTSC signal) compliant with the display specifications of the display section 6 in accordance with moving image data generated by the slideshow generating section 1 and outputs the video signal to the display section 6.

The slideshow generating apparatus may be a cellular phone or a digital camera.

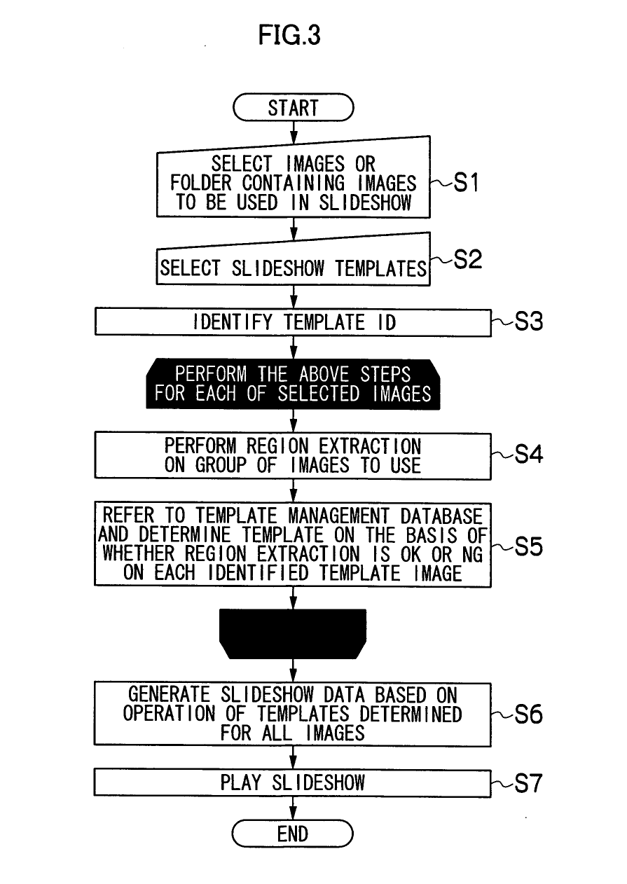

A process flow in the apparatus will be described with reference to FIG. 3.

At S1, original images to be used in a slideshow are selected from among the original images in the image managing section 4 in response to an input operation by a user. If the user finds specifying original images one by one cumbersome, the user may be allowed to select a folder containing images, and all the images in the folder may be used as original images.

At S2, a template that specifies a type of operation of the slideshow is selected from among the templates in the template managing section 5 in response to an input operation by the user.

At S3, the ID of the selected template that specifies the operation type is identified.

At S4, the region extracting section 2 tries to extracts a particular region from the original images. If the region extracting section 2 has successfully extracted a particular region, the region extracting region 2 outputs an Extraction OK signal to the slideshow generating section 1; otherwise, the region extracting region 2 outputs an Extraction NG signal to the slideshow generating section 1.

At S5, the slideshow generating section 1 refers to template-management information in the template managing section 5 to identify the ID of a template that defines a display condition associated with the ID of the template of the type of operation identified at S3 and the Extraction OK or NG signal output at S4.

It should be noted that S4 and S5 are performed for each of the selected original images.

At S6, the slideshow generating section 1 generates moving image data in which each of the original images is displayed with the identified operation type and display condition.

At S7, the image processing section 3 generates the video signal of a moving image to be displayed on the display section 6 in accordance with the generated moving image data and outputs it to the display section 6. When the vide signal is input in the display section 6, the display section 6 displays the moving image.

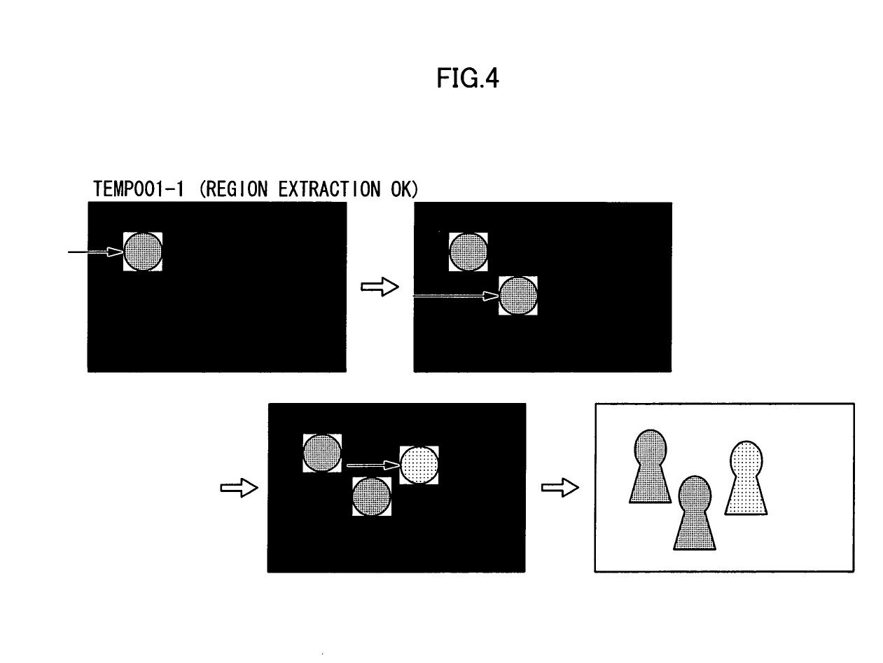

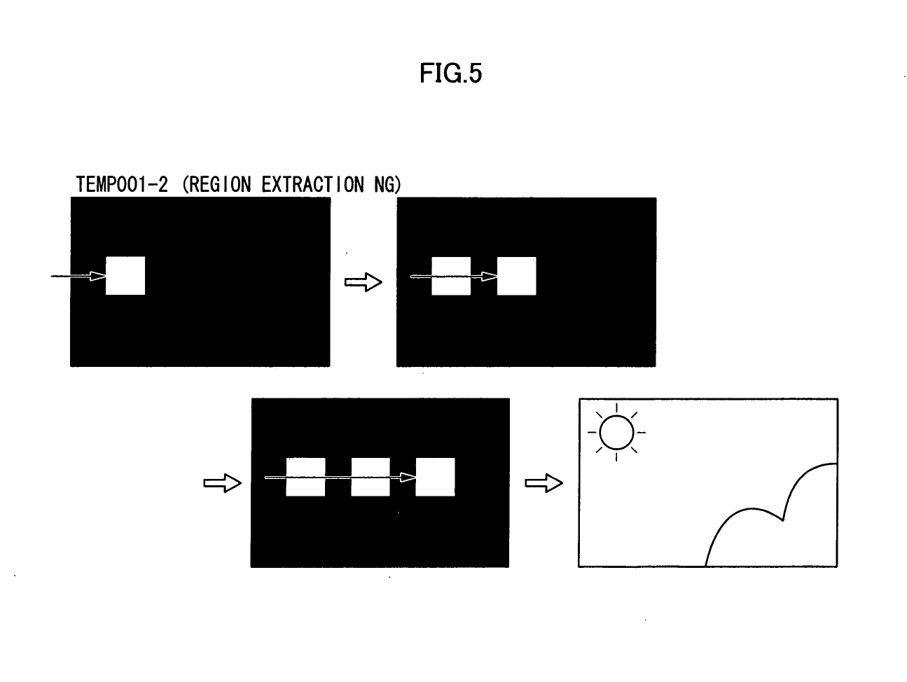

FIGS. 4 and 5 show an exemplary display condition depending on whether extraction has been performed or not in a case where the particular region is a human face. If face region extractions (three in this example) have been performed, the regions other than the human face region are masked and a hollow region of the mask in which only the human face is displayed is moved from the left to right of the screen as shown in FIG. 4 to add visual interest to the display of the human face portion.

If a human face region has not been extracted, it means that a human region cannot be located. Therefore, the hollow region is moved from the left center to right center of the screen as shown in FIG. 5.

In this way, the slideshow generating section 1 generates moving image data with a display condition dependent on whether or not a particular region has been extracted from original images. As a result, the visibility of the particular region in the moving image is improved and visual interest is added to the particular region.

### Second Embodiment

A display condition may be changed depending on the accuracy of extraction of a particular region (a numeric value indicating the likelihood of presence of a particular region in an extracted region).

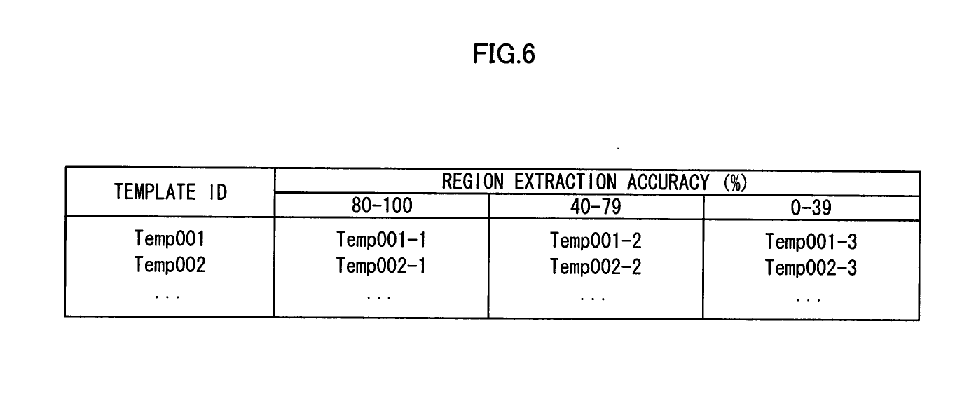

FIG. 6 is a conceptual diagram illustrating template management information according to a second embodiment. The information specifies a display condition according to a range of extraction accuracies of a particular region for each operation type template. For example, the template “Temp001” is associated with the display condition “temp001-1” for the extraction accuracy range “80-100”, the display condition “temp001-2” for the extraction accuracy range “40-79”, and the display condition “temp001-3” for the extraction accuracy range “0-39”.

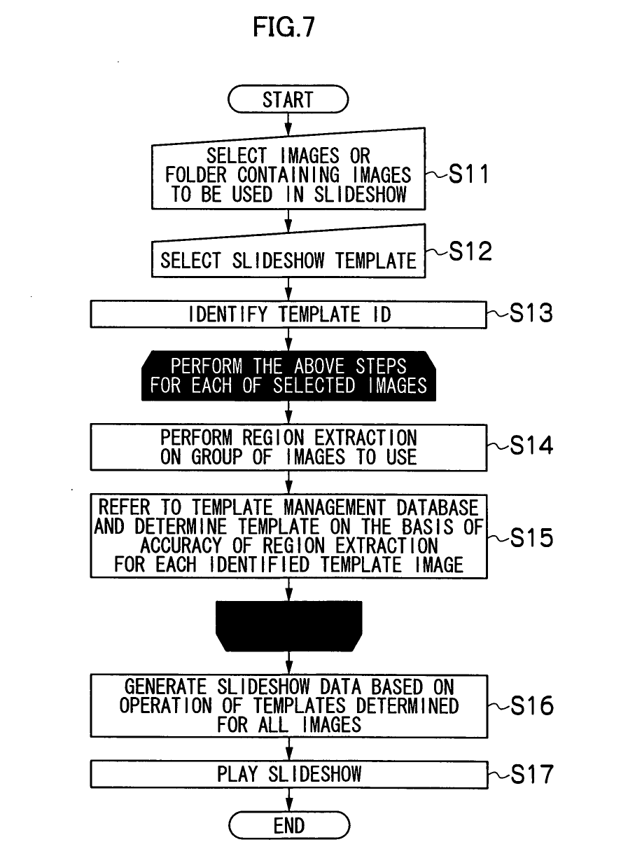

A process flow in an apparatus according to the second embodiment will be described with reference to FIG. 7.

At S11, original images to be used in a slideshow are selected from among the original images in an image managing section 4 in response to an input operation by a user.

At S12, a template that specifies the type of operation of the slideshow is selected from the templates in a template managing section 5 in response to an input operation by the user.

At S13, the ID of the selected operation type template is identified.

At S14, a region extracting section 2 tries to extract a particular region from an original image. The region extracting section 2 outputs a value (in the range 0-100) of the extraction accuracy of the particular region to a slideshow generating section 1.

At step S15, the slideshow generating section 1 refers to template management information in the template managing section 5 to identify the ID of a display condition associated with the ID of the identified operation type template and with the extraction accuracy of the particular region.

Steps S14 and S15 are performed for each of the selected original images.

At S16, the slideshow generating section 1 generates moving image data in which each of the original images is displayed with the identified operation type and display condition.

At S17, an image processing section 3 generates the video signal of the moving image to be displayed on a display section 6 on the basis of the generated moving image data, and outputs it to the display section 6. When the video signal is input in the display section 6, the display section 6 displays the moving image.

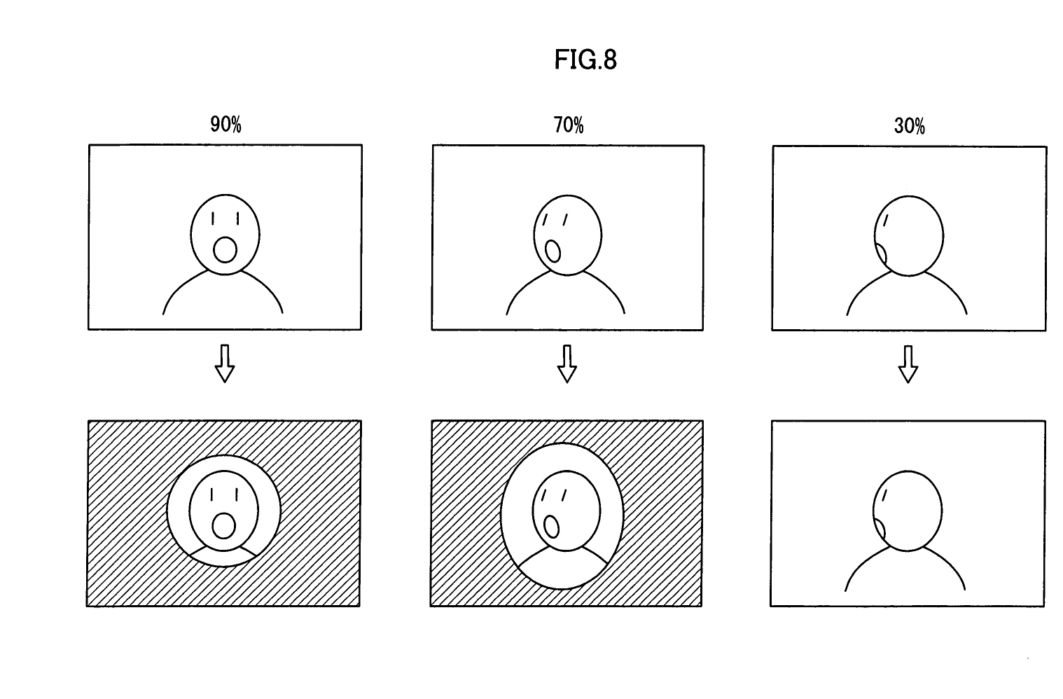

FIG. 8 shows exemplary display conditions for different extraction accuracies in an example where the particular region is a human face. If the extraction accuracy is 90%, the regions other than the human face are masked. Since the accuracy of extraction is high, the edge of the hollow region of the mask that is not masked is set closer to the edge of the particular region to minimize the area of the hollow region, thereby improving the appearance. If the accuracy of extraction is 70%, which is somewhat low, it is uncertain whether particular region actually exists in the extracted region. Therefore, the hollow region is somewhat widened. If the accuracy of extraction is 30%, the likelihood of the presence of a particular region is low and a masking region would overlap and hide a particular region. Therefore, masking is not performed.

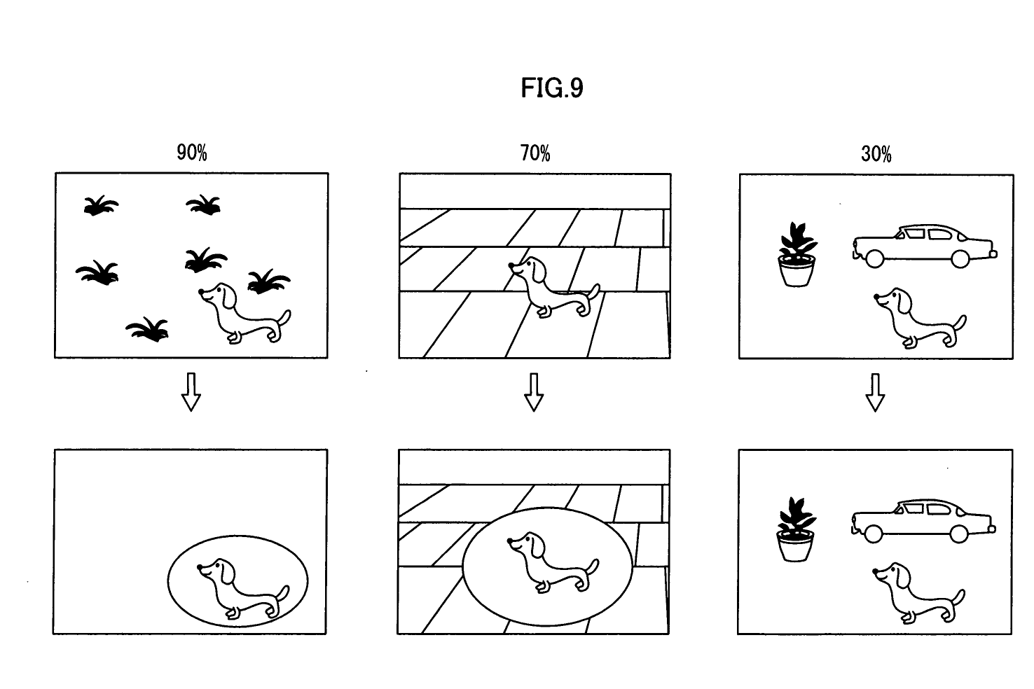

FIG. 9 shows exemplary display conditions for different accuracies in an example where the particular region is an animal. In the case of a simple background such as s field, the accuracy of extraction of a particular region will be high (90%). Therefore, the area of the particular region is minimized. In the case of a complicated background such as a tiled area where the accuracy of extraction is somewhat low (70%), the hollow region of is somewhat widened. In the case of a background in which various objects exist and therefore the accuracy of extraction is low (30%), masking is not performed.

By setting a display condition dependent on the likelihood of presence of a particular region in this ways, the visibility of the particular region in the moving image can be improved.

### Third Embodiment

A display condition may be set in accordance with the type of an extracted particular region, in addition to whether or not a particular region has been extracted or the accuracy of extraction.

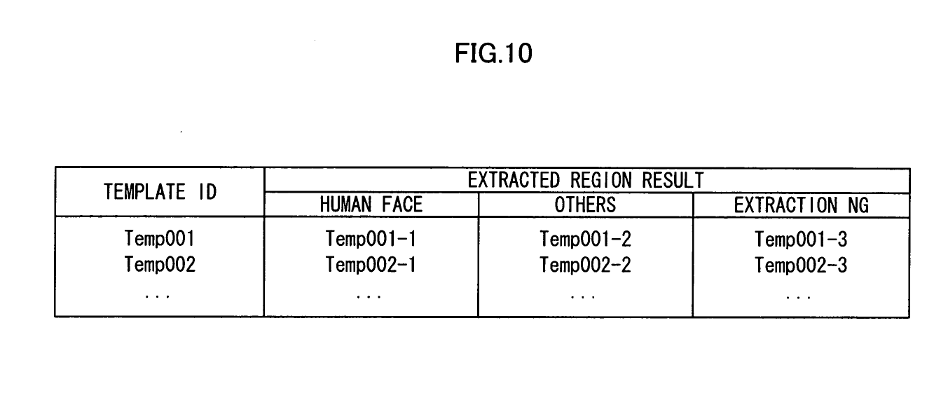

FIG. 10 is a conceptual diagram illustrating template management information according to a third embodiment. The information specifies a display condition according to the type of operation of a template, to whether or not a particular region has been extracted, and to the type of the particular region if extracted. In this example, the template operation type “Temp001” and the type of an extracted particular region “human face” are associated with the display condition “temp001-1”, the template operation type “Temp001” and the type of an extracted region “others” are associated with the display condition “temp001-2”, and the template type “Temp001” and the particular region extraction NG signal are associated with the display condition “temp001-3”.

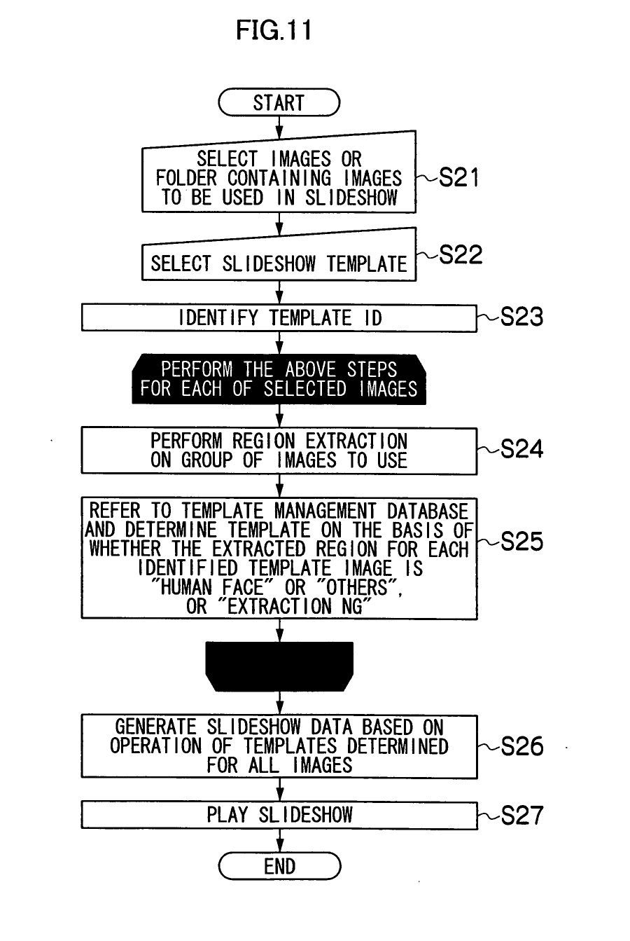

A process flow in an apparatus according to the third embodiment will be described with reference to FIG. 11.

At S21, original images to be used in a slideshow are selected from among original images in an image managing section 4 in response to an input operation by a user.

At S22, a template that specifies the type of operation of the slideshow is selected from the templates in a template managing section 5 in response to an input operation by the user.

At S23, the ID of a template of the selected operation type is identified.

At S24, a region extracting section 2 tries to extract a particular region from the original image. If the region extracting section 2 has extracted a particular region, the region extracting section 2 outputs the type of the extracted particular region as an Extraction OK signal; otherwise, the region extracting section 2 outputs an Extraction NG signal.

At S25, a slideshow generating section 1 refers to template management information in a template managing section 5 to identify the ID of a display condition associated with the ID of an operation type template, with whether or not a particular region has been extracted, and with the type of the particular region if extracted.

Steps S24 and S25 are performed on each of the selected original images.

At S26, the slideshow generating section 1 generates moving image data in which each of the original images is displayed with the identified type of operation and display condition.

At S27, an image generating section 3 generates the video signal of the moving image to be displayed in a display device 6 on the basis of the generated moving image data and outputs it to the display section 6. When the video signal is input in the display section 6, the display section displays the moving image.

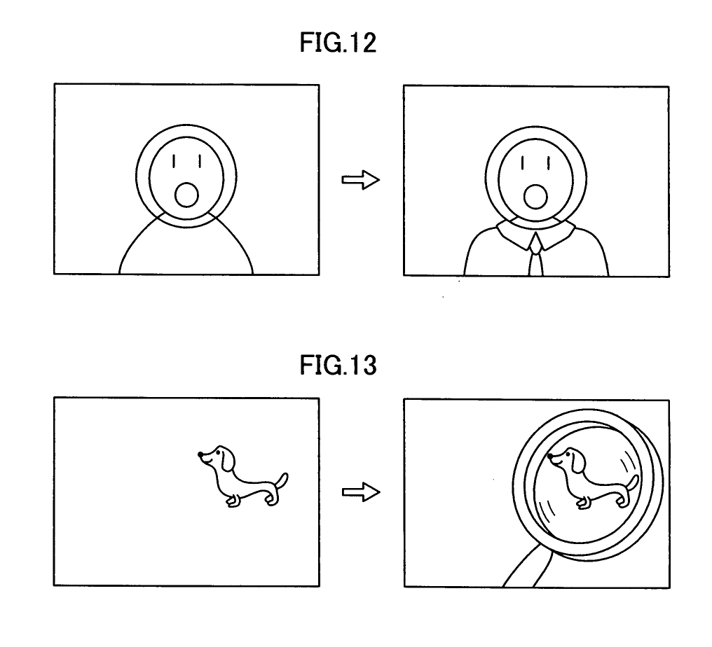

FIG. 12 shows an example of a masking region generated in a case where the type of an extracted particular region is a human face. The clothes are used as the masking region in agreement with the human face.

FIG. 13 shows an example of a masking region generated in a case where the type of an extracted particular region is an animal, instead of a human face. The masking region is a magnifying glass in agreement with the subject which is not a human face.

By setting a display condition in accordance with the type of a particular region in this way, the visibility of the particular region in a moving image can be improved and the moving image can be made pleasant.

What is claimed is:

1. An image processing apparatus which generates moving image data on the basis of a still image, comprising:
a database storing a moving image template specifying a display condition dependent on whether or not a particular region has been extracted;
a region extracting section which extracts the particular region from the still image; and
a moving image data generating section which reads from the database a moving image template specifying a display condition dependent on whether or not the particular region has been extracted by the region extracting section and generates moving image data based on the still image and the moving image template.

2. The image processing apparatus according to claim 1, wherein the database stores a moving image template which specifies a display condition dependent on whether or not the particular region has been extracted and on the accuracy of extraction of the particular region; and
the moving image data generating section reads from the database a moving image template which specifies a display condition dependent on whether or not a particular region has been extracted by the region extracting section and on the accuracy of extraction and generates moving image data based on the still image and the moving image template.

3. The image processing apparatus according to claim 1, wherein the database stores a moving image template specifying a display condition dependent on whether or not the particular region has been extracted and on the type of the extracted particular region;
the region extracting section extracts the particular region and the type of the particular region from the still image; and
the moving image data generating section reads from the database a moving image template specifying a display condition dependent on whether or not a particular region has been extracted by the region extracting section and on the type of the extracted particular region and generates moving image data based on the still image and the moving image template.

4. The image processing apparatus according to claim 2, wherein the database stores a moving image template specifying a display condition dependent on whether or not the particular region has been extracted and on the type of the extracted particular region;
the region extracting section extracts the particular region and the type of the particular region from the still image; and
the moving image data generating section reads from the database a moving image template specifying a display condition dependent on whether or not a particular region has been extracted by the region extracting section and on the type of the extracted particular region and generates moving image data based on the still image and the moving image template.

5. The image processing apparatus according to claim 1, wherein the particular region includes a region in which an image of a human face exists.

6. The image processing apparatus according to claim 2, wherein the particular region includes a region in which an image of a human face exists.

7. The image processing apparatus according to claim 3, wherein the particular region includes a region in which an image of a human face exists.

8. The image processing apparatus according to claim 4, wherein the particular region includes a region in which an image of a human face exists.

9. An image processing method for generating a moving image data on the basis of a still image, comprising the steps of:
storing a moving image template in a database, the moving image template specifying a display condition dependent on whether or not a particular region has been extracted;
extracting the particular region from the still image; and
reading from the database a moving image template specifying a display condition dependent on whether or not the particular region has been extracted and generating moving image data based on the still image and the moving image template.

10. A program for causing a computer to perform the image processing method according to claim 9.
